(19) United States
(12) Patent Application Publication
(10) Pub. No.: US 2015/0032628 A1
(43) Pub. Date: Jan. 29, 2015

(54) Payment Authorization System

(71) Applicant: Barclays Bank PLC, London (GB)

(72) Inventor: Lee Randall, Longwick (GB)

(21) Appl. No.: 14/444,398

(22) Filed: Jul. 28, 2014

(30) Foreign Application Priority Data
Jul. 29, 2013 (GB) 1313491.1

(51) Int. Cl. G06Q 20/40

(52) U.S. Cl. CPC G06Q 20/40; G06Q 50/01
USPC 705/44

(57) ABSTRACT

A payment system determines a required level of authentication for a payment transaction by a candidate consumer, based on a correlation with transactions by other consumers related to the candidate consumer, identified for example from one or more social networks. The correlation may be based on geographical location, time and/or type of transaction. A high correlation may indicate a group activity which requires a lower level of authentication.

### FIELD OF THE INVENTION

This invention relates to a method and system for authorizing payment transactions using a payment service provider.

### BACKGROUND OF THE INVENTION

Conventional methods of online payment include an online checkout model, where payment may be effected by entering details of a payment card, including card number, card holder name, card expiry data, CVC (Card Verification Code) code and billing address.

An additional level of security for online transactions may be provided by authentication with the card issuer, for example using the 3-D Secure protocol (which is is an XML-based protocol designed to by Visa™ be an additional security layer for online credit and debit card transactions. However, this requires additional details to be entered which the user may find tiresome, and increases the probability that a bona fide consumer will not bother to complete the transaction.

Online payments are an example of ‘Card Not Present’ (CNP) transactions, which are inherently insecure because the card details may be copied without gaining possession of the physical card. Card Present (CP) transactions, such as Point-of-Sale (PoS) transactions provide an additional level of security using a physical card, for example by means of an EMV (Europay, Mastercard and Visa) chip and a PIN (Personal Identification Number) entered by the user. However, CP transactions are still susceptible to fraud, for example by theft or cloning of the card and obtaining the PIN. Hence, if potential fraud is detected, the card issuer may decline an automated Card Present transaction with a ‘Refer to Issuer’ code. The merchant or customer must then call the issuer and provide further details. Although such measures increase security, they provide an additional burden on the customer.

In summary, both for CNP and CP transactions there is a tension between the need for an adequate level of security and the burden provided on a bona fide customer in meeting that level of security.

### SUMMARY OF THE INVENTION

In an embodiment of the invention, a payment system processes payment for a current transaction initiated between a candidate consumer and a merchant by determining a correlation between the current transaction and other transactions by connected consumers having known or implied social connections with the candidate consumer. In addition, a required level of authentication for the current transaction in dependence on the correlation is determined In this way, consumers participating in correlated transactions may benefit from lower levels of authentication, as the correlation between the transactions provides an inherent level of security.

The other transaction may comprise transactions by other consumers with the same merchant or merchant type as in the current transaction. In this way, a group of transactions involving the same merchant, such as a group holiday booking or restaurant payment, may be identified.

The correlation may be dependent on the location, time and/or type of the current transaction and the other transactions.

The known social connections between the current consumer and the connected consumers may be determined from explicit connections, such as social network connections, verified family relationships or shared addresses, or implicit connections derived from behavioural data such as historical transaction data.

The required levels of authentication may involve different levels of interaction with the candidate customer. For example, a low level of authentication may require the candidate customer to present only card payment details in the case of an online transaction, or a physical card in the case of a PoS transaction. A higher level of authentication may require the candidate consumer to present a PIN or passcode, and/or personal details such as date of birth or biometric data.

In other aspects, there is provided a system comprising mechanisms for carrying out the methods as described above. In another aspect, there is provided a computer program arranged to carry out the method when executed by suitable programmable devices.

### BRIEF DESCRIPTION OF THE DRAWINGS

There now follows, by way of example only, a detailed description of embodiments of the present invention, with references to the figures identified below:

FIG. 1 is a schematic block diagram illustrating the main components of an overall online payment environment according to an embodiment of the invention;

FIG. 2 is a flow diagram illustrating the main processing steps performed by the payment system in an electronic online payment process for a transaction;

FIG. 3 is a schematic block diagram of the payment system of FIG. 1, illustrating in more detail the exemplary data units and flows of data between components of the payment system according to an embodiment of the invention;

FIG. 4, which comprises FIGS. 4a to 4c, is a schematic illustration of exemplary web pages served by the payment system to a consumer device according to the scaled authentication process of an alternative embodiment; and

FIG. 5 is a diagram of an example of a computer system on which one or more of the functions of the embodiments may be implemented.

### DETAILED DESCRIPTION OF THE INVENTION

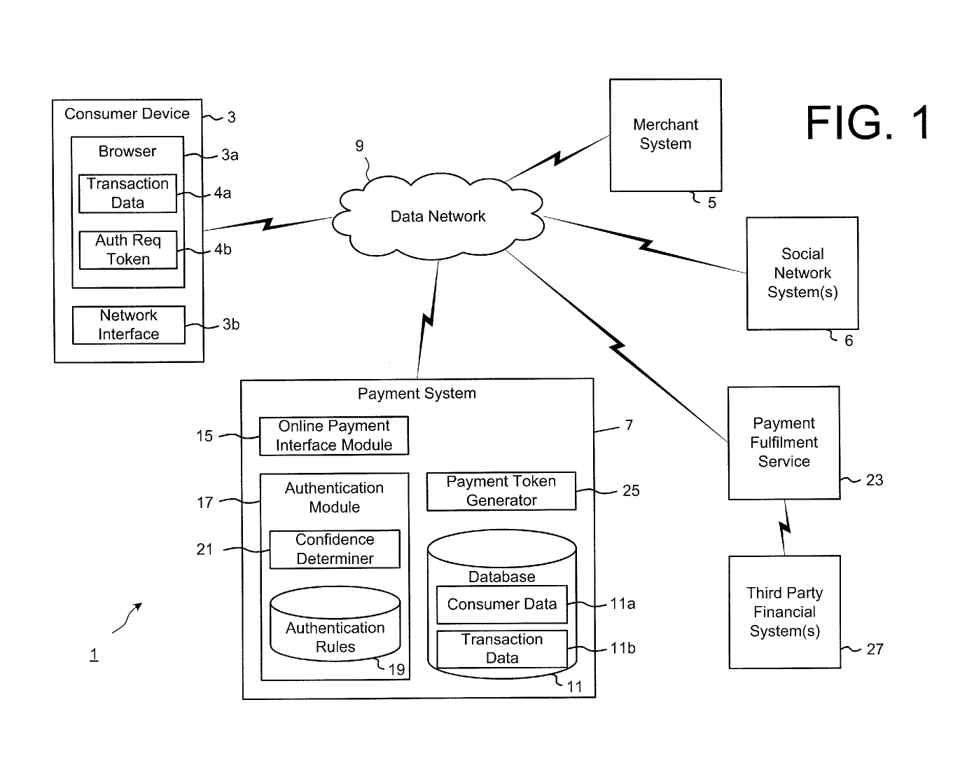

Referring to FIG. 1, a system in the form of an online payment environment 1 according to embodiments of the invention comprises a consumer device 3 associated with a consumer wishing to effect a payment transaction for purchase of a product or service provided by a merchant, via a payment system 7 associated with an intermediary payment service provider. The consumer device 3 is connected or connectable to a merchant system 5 associated with the merchant over a data network 9. The consumer device 3 and the merchant system 5 are also connected or connectable to the payment system 7 over the data network 9.

It will be appreciated that the consumer can be interchangeably referred to as a customer, user, end user or the like, the merchant can be interchangeably referred to as a retailer, vendor, business, broker, service provider or the like, and the intermediary payment service provider can be interchangeably referred to as a payment service provider, payment issuer or the like.

The consumer device 3 is of a type that is known per se, such as a desktop computer, laptop computer, a tablet computer, a smartphone such as an iOS™, Blackberry™ or Android™ based smartphone, a ‘feature’ phone (that is, low-end mobile phones which are limited in capabilities, and whose features commonly provide for voice calling and text messaging, as well as basic multimedia and Internet capabilities), a personal digital assistant (FDA), or any processor-powered device with suitable input and display means. The device 3 may also be a terminal of the network 9.

The data network 9 comprises a terrestrial cellular network such as a 2G, 3G or 4G network, a private or public wireless network such as a WiFi™-based network and/or a mobile satellite network or the Internet. A plurality of, and preferably a large number of consumer devices 3 and merchant systems 5 are operable concurrently within the online payment environment 1 of the present online payment environment 1.

The consumer device 3 has a browser application 3a, or a dedicated application, for accessing and interacting with an online store hosted by the merchant system 5 connected to the network 9. The online store displays items that a consumer may select for purchase, and stores the selected item(s) selected by the consumer during a session in a ‘basket’ or other model representing a set of items selected for purchase, illustrated generally in FIG. 1 as transaction data 4a. The merchant system 5 may comprise multiple components (not shown), such as a web server for serving web pages to a consumer's browser 3a and a back-end server for storing data representing consumers and baskets, and interfacing with payment systems, such as the intermediary payment system 7. The consumer device 3 may be a client of the merchant system 5, although embodiments of the invention may not be limited to a client-server model.

The payment system 7 interacts with the consumer device 3 to authorize and process payments by interaction with an authenticated user of the consumer device 3.

The payment system 7 has access to one or more database(s) 11 including consumer data 11a relating to subscribers or registered users of the payment service provider. The database 11 also includes transaction data 11b relating to historical transaction sessions by subscribers or registered users of the payment service provider.

The consumer data 11a includes consumer relationship data identifying social or other relationships between different registered consumers. The consumer relationship data may be determined explicitly, for example from social network data derived from one or more external electronic social network systems 6, such as Facebook®, MySpace® or LinkedIn®. Using multiple social networks increases the confidence in the consumer relationship data and may reduce or even eliminate the need for traditional authorization rules.

During registration with the payment service, a user may be prompted to enter their social network system login details, which are then used by the payment system 7 to generate and update the consumer relationship data; alternatively, the consumer relationship data may be obtained on demand from the social network system(s) 6.

Alternatively or additionally, the consumer relationship data may be determined implicitly from the transaction data 11b or other data available to the payment system 7. For example, registration of different consumers at the same address may be used to derive a family or group relationship between consumers.

The consumer relationship data may comprise, for each consumer, links to other registered consumers determined to be related. The links may correspond for example to first degree links in a social network. Additionally, the consumer relationship data may include weights or other identifiers indicating the determined strengths of relationships to other registered consumers. The weights may correspond, for example, to proximity on the social network so that, for example, a first degree link is weighted more heavily than a second degree link.

In the exemplary embodiment illustrated in FIG. 1, the browser application 3a of the consumer device 3 accesses and interacts with an online payment interface module 15 to provide credentials for authentication as one or more authentication request token(s) 4b. The online payment interface module 15 can serve one or more web page(s), or portion(s) of a web page such as inline frames or the like, to the consumer's browser 3a to prompt for a set of credentials for authentication.

The payment system 7 also includes an authentication module 17 that determines the set of credentials to request from the consumer device 3 for authentication based on predefined authentication rules 19. As will be described in more detail below, the authentication module 17 includes a confidence determiner module 21 to determine a confidence measure for the consumer based on the received credentials and associated consumer data 11a for other associated consumers that is stored in the database 11.

The payment system 7 may be connected to, or may comprise a payment fulfilment service 23 of a type that is known per se. The payment fulfilment service 23 receives payment tokens from a generator module 25 in the payment system 7 and executes the requested payments between specified consumer and merchant accounts. It is appreciated that the consumer and merchant accounts can be maintained by the payment system 7 and/or conventional third party financial system(s) 27, such as a bank card issuer, a merchant acquirer, a financial institution, a business entity or the like. Preferably, although not necessarily, the payment system 7 is associated with a payment account issuer that maintains at least one designated financial account and/or stored value account for the consumer, thereby enabling secure and direct access to a greater set of consumer data 11a, such as historical account activity-related details 31c that can be directly updated by the payment system 7 as the consumer uses the account.

In an alternative embodiment, payment may be made in a PoS environment of a type that is known per se. In this embodiment, the consumer authorizes a transaction directly with the merchant system 5, using for example an EMV system, rather than online via the consumer device.

Payment Process

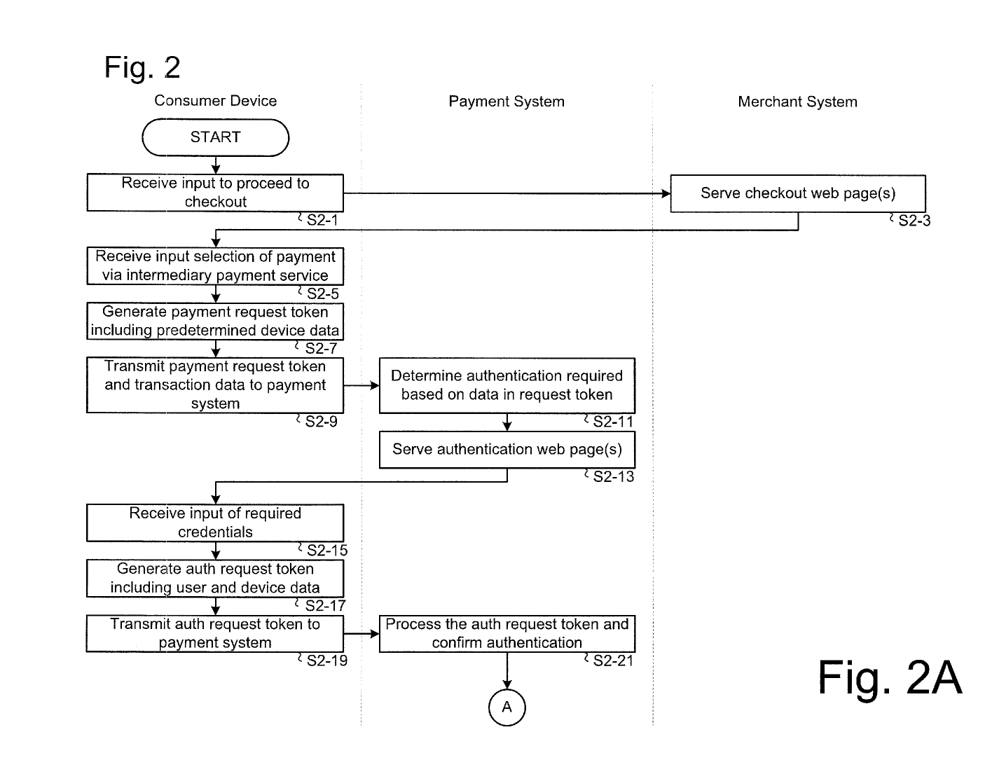

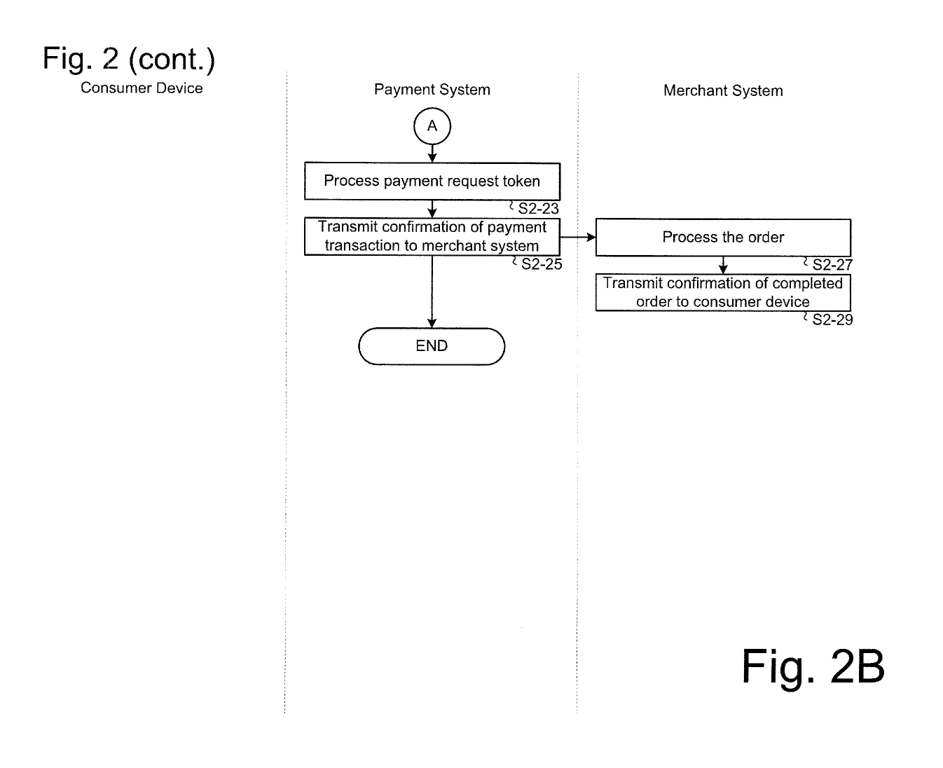

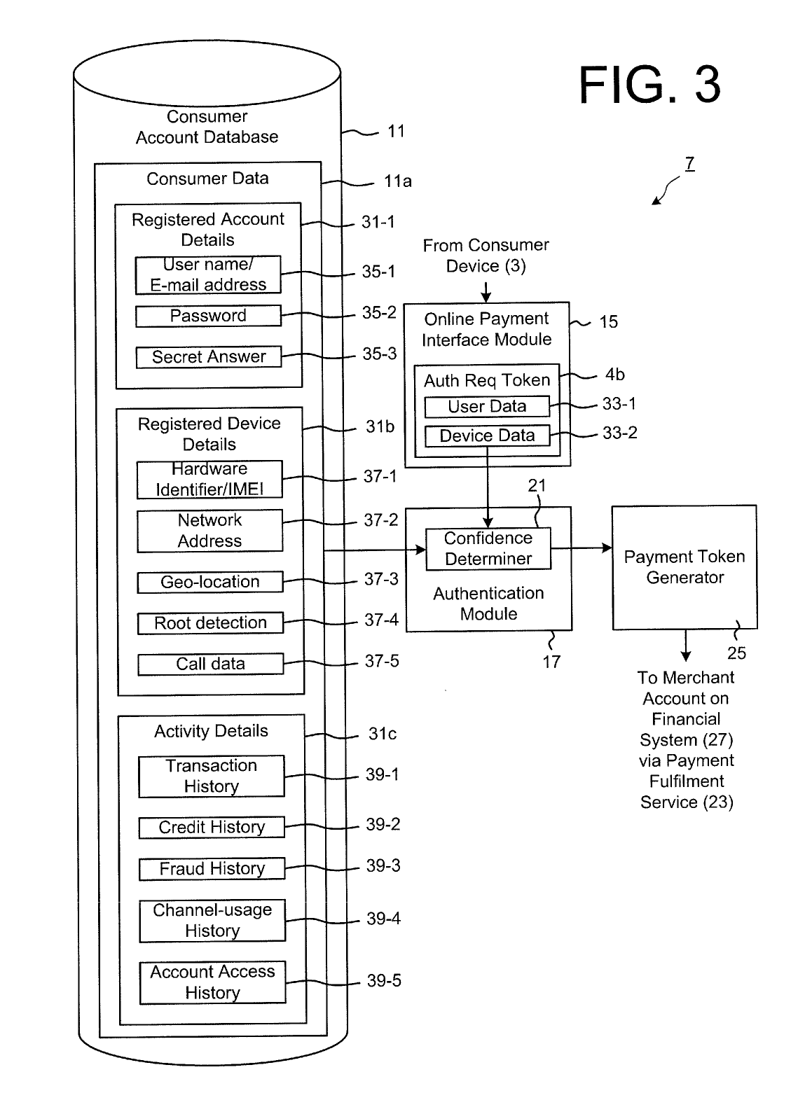

A brief description has been given above of the main components forming part of the online payment environment 1 of an exemplary embodiment. A more detailed description of the operation of these components will now be given with reference to the flow diagram of FIG. 2, which is an exemplary computer-implemented online order and payment process between the consumer device 3 and the merchant system 5 in data communication with the payment system 7. Reference is also made to the schematic block diagram of FIG. 3 illustrating in more detail the exemplary data units and flows of data between components of the payment system 7 according to the described embodiments.

The process begins after the consumer has finished browsing an online store, for example on the merchant's website using the browser 3a or other application, and has selected one or more items which have been added to a ‘basket’ or any other model representing selections for purchase. Accordingly, at step S2-1, the consumer device 3 receives input from the user wishing to complete the purchase by selecting a ‘checkout’ option on the website. At step S2-3, the merchant system 5 retrieves and serves the checkout web page to the consumer's browser 3a, the checkout web page including a plurality of user selectable options to instruct payment for the order by an associated payment instrument or service. At step S2-5, the consumer device 3 receives user input of a selected one of the payment options, which in this embodiment is payment via the payment system 7 associated with the intermediary payment service.

At step S2-7, the consumer device 3 generates a payment request token and transmits the token and transaction data to the payment system 7 at step S2-9. The transaction data, for example, includes the total amount to be paid, information on specific items within the basket such as name and individual cost, and/or any specific conditions associated with the purchase. Preferably, although not necessarily, the transaction data can be protected from tampering by suitable cryptographic means, for example by encryption, a digital signature or a hash-based authentication code (HMAC). Alternatively, the merchant system 5 can make the payment request token and/or the transaction data available to the payment system (or server) 7.

Optionally, the payment request token can include data indicative of predetermined device-related information 31-2 as pre-registered with the payment system 7, such as a hardware identifier 37-1 and network address 37-2. For mobile handset consumer devices, the hardware identifier can be the IMEI (International Mobile Station Equipment Identity) number 37-1, the network address can be the IMSI (International Mobile Subscriber Identity) and the registered device details 31-2 can further include data elements such as: the mobile identification number (MIN), a physical geo-location 37-3 at the time of the request (derived for example by cellular triangulation or a GPS receiver within the consumer device), root detection data 37-4 as typically used to identify whether the user of a mobile handset has access to the systems and software that are normally restricted to the operator or the handset manufacturers, historical call data 37-5, etc. In such an embodiment, the online payment interface module 15 of the payment system 7 then determines a level of authentication required for the consumer device 3 based on the data elements provided in the payment request token, as illustrated at step S2-11 in FIG. 2. The online payment interface module 15 can also determine a required level of authentication based on predefined authentication rules 19.

In the present embodiment, the authentication rules 19 include determining a level of confidence based on a correlation between the transaction data for the current transaction with the candidate consumer and the transaction data 11b for transactions by other consumers having a predetermined relationship with the candidate consumer, as recorded for example in the consumer data 11a. The correlation may be determined based on one or more of the following factors, for example:
whether the transactions were through the same merchant system 5 or merchant type;
whether the transactions were for similar goods or services;
geographical proximity between the consumers at the time of the transactions, as determined for example by the physical geolocation data 37-3; and/or
temporal proximity between the times of the transaction requests by the consumers.
   In general, a higher degree of correlation will result in a lower required level of authentication, subject to any other factors. A high degree of correlation is likely to represent a group activity, such as friends or family independently purchasing travel for a group holiday or gifts for a shared occasion such as a wedding or birthday. Such group activities are inherently more expected and therefore less suspect than individual, uncorrelated purchases.

In an alternative PoS embodiment, the above factors may be used for determining the correlation, although the consumer will not report physical geolocation data independent of the location of the merchant system 5 or merchant. In the PoS embodiment, a high correlation may indicate a group purchase such as sharing a bill at a restaurant.

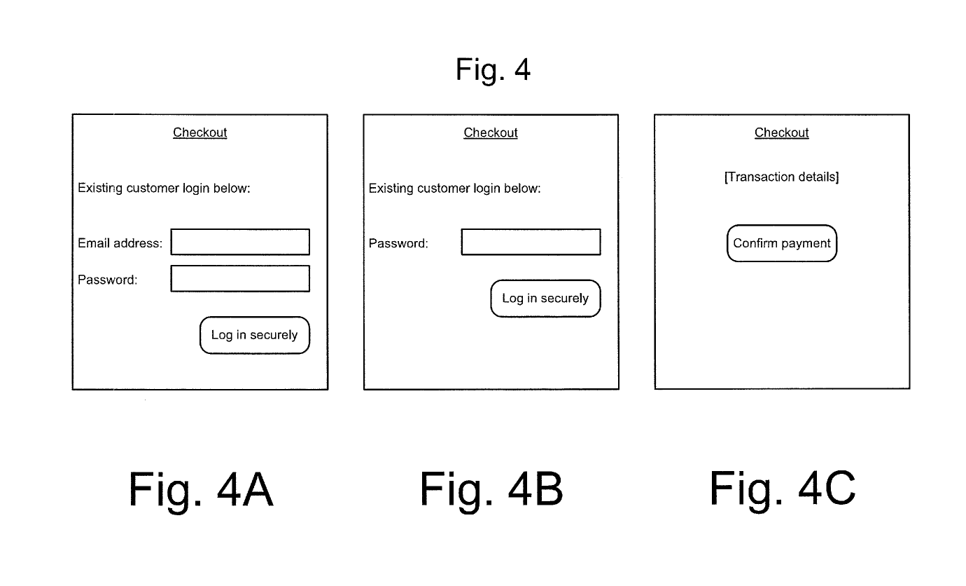

At step S2-13, the online payment interface module 15 serves the appropriate authentication web page to the consumer's browser 3a to prompt the user for their registered credentials 31-1. FIGS. 4a to 4c are schematic illustrations of exemplary checkout authentication web pages served by the payment system 7 to the consumer browser 3a according to the scaled authentication process of the alternative embodiment. As illustrated in FIG. 4a, when the provided device data and transaction details are determined to meet a low confidence threshold, the user can be prompted to enter a greater number of credentials 31-1 to validate the payment, such as both the registered user name or e-mail address 35-1 and password 35-2. Alternatively or additionally, the user can be prompted to provide a pre-registered secret answer 35-3 to a personal question, the registered mobile identification number (MIN), details of the consumer's last transaction, details of the consumer's registered postal address or a previous registered address, etc.

On the other hand, when the provided device data and transaction details are determined to meet a high confidence threshold, the user can be prompted to simply confirm payment for the transaction without requiring input of any credentials to validate the payment, as illustrated in FIG. 4c. Alternatively, a medium confidence threshold can be defined between the low and high confidence thresholds, whereby the user can be prompted to enter a lesser number of credentials to validate the payment, such as only the registered password 35-2, as illustrated in FIG. 4b.

As illustrated in the exemplary display screen of FIG. 4c, the authentication web page can be configured to display at least some of the transaction data to the user, when prompting the user to authorize the purchase of the items in the basket. The user may also be prompted to select from a list of registered modes of payment via the intermediary payment service, such as payment from a specific bank account registered with the payment system 7, and/or an electronic wallet or stored value account associated with the consumer device 3.

In a main embodiment, a default authentication web page is used to prompt the user to provide both the registered user name or e-mail address 35-1 and password 35-2, for example as illustrated in FIG. 3a. Accordingly, at step S2-15, the consumer device 3 receives user input of the required credentials and generates an authentication request token 4b including the input user data 33-1, at step S2-17. In this embodiment, the authentication request token 4b also includes predetermined device data 33-2, for example as discussed above. It will be appreciated that the authentication web page can include code to request the predetermined data elements from the consumer device 3 for return to authentication module 17, as is known in the art. At step S2-19, the consumer device 3 transmits the authentication request token 4b to the payment system 7.

At step S2-21, the authentication module 17 of the payment system 7 processes the received authentication request token 4b to determine and confirm that the user data 33-1 provided in the token matches the registered account details 31-1 stored in the database 11. It will be appreciated that mechanisms can be provided to handle authentication request tokens that do not include registered user data, such as prompting the consumer to re-enter details or to securely retrieve forgotten or lost credentials. After the authentication module 17 verifies the provided credentials and authorizes the authentication request, the payment system 7 may proceed to process the payment request token at step S2-23, for example by effecting payment from the designated user account to the merchant's account via the payment fulfilment service 23 in a conventional manner. After the payment transaction is processed, the payment system 7 transmits a payment outcome token to the merchant system 5 at step S2-25.

At step S2-27, the merchant system 5 processes the order in accordance with the outcome indicated by the payment outcome token. If the payment is authorized, the transaction is completed by processing the order for the items in the basket. If the payment is declined, the transaction is cancelled. Alternatively, the merchant system 5 prompts the consumer device 3 to query the payment system 7 with the original payment request token to find out the outcome, for example if the payment outcome token does not arrive at the merchant system 5 within a predefined time.

As an optional additional step, the merchant system 5 may be required to present the payment outcome token to the payment system 7 in order to confirm that the transaction has been completed, and payment to the merchant may be suspended until this additional step is completed.

In the alternative PoS environment, the different levels of authentication are requested at the PoS terminal of the merchant system 5. For example, at a low level of authentication the customer may not be required to enter their PIN in an EMV system, while at a high level of authentication, not only a PIN but additional personal or biometric data may be required.

In either an online or PoS embodiment, the payment system 7 scales the authentication process for a consumer device 3 depending on a level of confidence based on a correlation with transactions by other, related consumers. A simplified check-out and payment experience is therefore provided for consumers that meet a high confidence threshold without compromising security from other consumers associated with a lower confidence.

Computer Systems

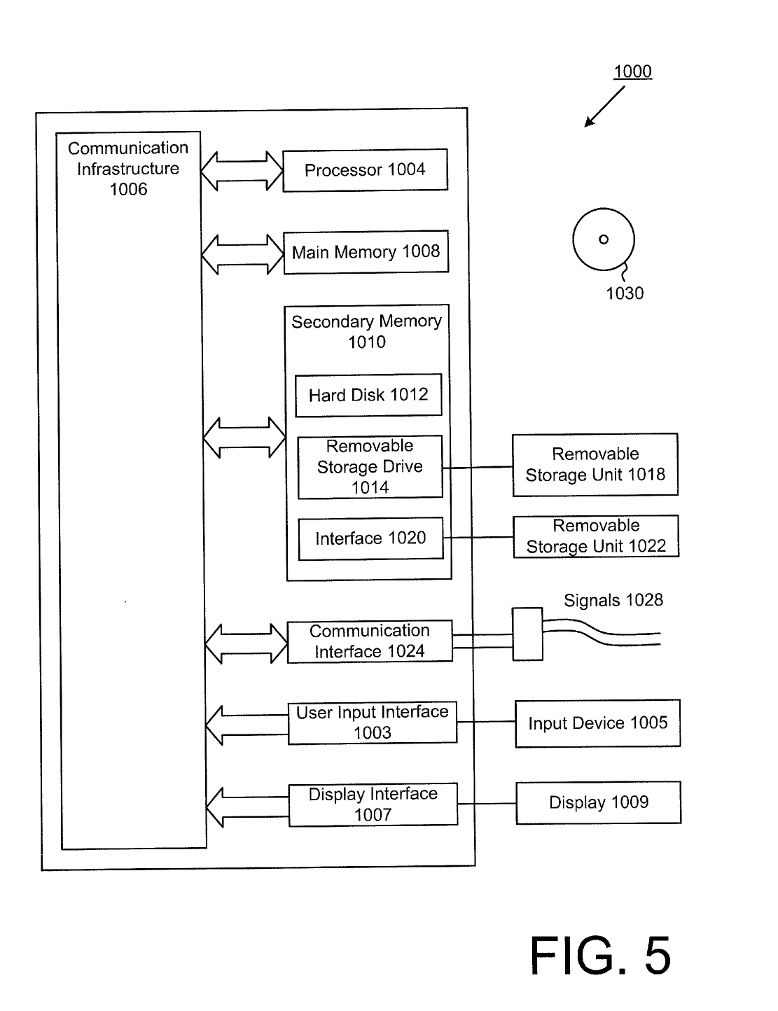

The entities described herein, such as the consumer device, the merchant system and the payment system, may be implemented by computer systems such as computer system 1000 as shown in FIG. 5. Embodiments of the present invention may be implemented as programmable code for execution by such computer systems 1000. After reading this description, it will become apparent to a person skilled in the art how to implement the invention using other computer systems and/or computer architectures.

Computer system 1000 includes one or more processors, such as processor 1004. Processor 1004 may be any type of processor, including but not limited to a special purpose or a general-purpose digital signal processor. Processor 1004 is connected to a communication infrastructure 1006 (for example, a bus or network). Various software implementations are described in terms of this exemplary computer system. After reading this description, it will become apparent to a person skilled in the art how to implement the invention using other computer systems and/or computer architectures.

Computer system 1000 also includes a user input interface 1003 connected to one or more input device(s) 1005 and a display interface 1007 connected to one or more display® 1009. Input devices 1005 may include, for example, a pointing device such as a mouse or touchpad, a keyboard, a touchscreen such as a resistive or capacitive touchscreen, etc. After reading this description, it will become apparent to a person skilled in the art how to implement the invention using other computer systems and/or computer architectures, for example using mobile electronic devices with integrated input and display components.

Computer system 1000 also includes a main memory 1008, preferably random access memory (RAM), and may also include a secondary memory 610. Secondary memory 1010 may include, for example, a hard disk drive 1012 and/or a removable storage drive 1014, representing a floppy disk drive, a magnetic tape drive, an optical disk drive, etc. Removable storage drive 1014 reads from and/or writes to a removable storage unit 1018 in a well-known manner. Removable storage unit 1018 represents a floppy disk, magnetic tape, optical disk, etc., which is read by and written to by removable storage drive 1014. As will be appreciated, removable storage unit 618 includes a computer usable storage medium having stored therein computer software and/or data.

In alternative implementations, secondary memory 1010 may include other similar means for allowing computer programs or other instructions to be loaded into computer system 1000. Such means may include, for example, a removable storage unit 1022 and an interface 1020. Examples of such means may include a program cartridge and cartridge interface (such as that previously found in video game devices), a removable memory chip (such as an EPROM, or PROM, or flash memory) and associated socket, and other removable storage units 1022 and interfaces 1020 which allow software and data to be transferred from removable storage unit 1022 to computer system 1000. Alternatively, the program may be executed and/or the data accessed from the removable storage unit 1022, using the processor 1004 of the computer system 1000.

Computer system 1000 may also include a communication interface 1024. Communication interface 1024 allows software and data to be transferred between computer system 1000 and external devices. Examples of communication interface 1024 may include a modem, a network interface (such as an Ethernet card), a communication port, a Personal Computer Memory Card International Association (PCMCIA) slot and card, etc. Software and data transferred via communication interface 1024 are in the form of signals 1028, which may be electronic, electromagnetic, optical, or other signals capable of being received by communication interface 1024. These signals 1028 are provided to communication interface 1024 via a communication path 1026. Communication path 1026 carries signals 1028 and may be implemented using wire or cable, fibre optics, a phone line, a wireless link, a cellular phone link, a radio frequency link, or any other suitable communication channel. For instance, communication path 1026 may be implemented using a combination of channels.

The terms “computer program medium” and “computer usable medium” are used generally to refer to media such as removable storage drive 1014, a hard disk installed in hard disk drive 1012, and signals 1028. These computer program products are means for providing software to computer system 1000. However, these terms may also include signals (such as electrical, optical or electromagnetic signals) that embody the computer program disclosed herein.

Computer programs (also called computer control logic) are stored in main memory 1008 and/or secondary memory 1010. Computer programs may also be received via communication interface 1024. Such computer programs, when executed, enable computer system 1000 to implement embodiments of the present invention as discussed herein.

Accordingly, such computer programs represent controllers of computer system 1000. Where the embodiment is implemented using software, the software may be stored in a computer program product 1030 and loaded into computer system 1000 using removable storage drive 1014, hard disk drive 1012, or communication interface 1024, to provide some examples.

Alternative embodiments may be implemented as control logic in hardware, firmware, or software or any combination thereof.

### ALTERNATIVE EMBODIMENTS AND MODIFICATIONS

For example, in the embodiments described above, the intermediary payment system is provided as a separate component to the third party financial systems. It is appreciated that the payment system may alternatively be provided as a component of a financial institution's system, such as the customer's and/or merchant's financial institution, thereby removing the need for the payment tokens to be communicated to the destination financial institution via a payment scheme network.

What is claimed is:

1. A method of determining a required level of authentication for a candidate transaction initiated between a candidate consumer and a merchant system via a payment system, the method comprising, at the payment system, the steps of:
i. receiving candidate transaction data relating to the candidate transaction and user data relating to an identity of the candidate consumer registered with the payment system;
ii. identifying related transaction data for other transactions by other consumers registered with the payment system and having a predetermined relationship with the candidate consumer; and
iii. determining a level of authentication of the candidate consumer required to authorize the candidate transaction based on the related transaction data.

2. The method of claim 1, wherein the predetermined relationship comprises an explicit social relationship derived from at least one electronic social network system.

3. The method of claim 1, wherein the predetermined relationship comprises an implicit social relationship derived from consumer data.

4. The method of claim 3, wherein the implicit social relationship is derived from consumer transaction data.

5. The method of claim 1, wherein the required level of authentication is based on a correlation between one or more predetermined factors of the candidate transaction and the other transactions.

6. The method of claim 5, wherein the one or more predetermined factors comprise an identity of a merchant, a type of goods or services to be purchased, a geographical location of the candidate consumer, and/or a time of the candidate transaction.

7. The method of claim 1, wherein the merchant system comprises an online purchasing system.

8. The method of claim 1, wherein the merchant system comprises a point-of-sale system.

9. The method of claim 1, wherein the payment system indicates the required level of authentication to the merchant system.

10. A system of determining a required level of authentication for a candidate transaction initiated between a candidate consumer and a merchant system via a payment system, the system comprising:
an authentication module receiving candidate transaction data relating to the candidate transaction and user data relating to an identity of the candidate consumer registered with the payment system;
the authentication module identifying related transaction data for other transactions by other consumers registered with the payment system and having a predetermined relationship with the candidate consumer; and
a confidence determiner determining a level of authentication of the candidate consumer required to authorize the transaction, based on the related transaction data.

11. The system of claim 10, wherein the predetermined relationship comprises an explicit social relationship derived from at least one electronic social network system or an implicit social relationship derived from consumer data.

12. The system of claim 11, wherein the implicit social relationship is derived from consumer transaction data.

13. The system of claim 10, wherein the required level of authentication is based on a correlation between one or more predetermined factors of the candidate transaction and the other transactions.

14. The system of claim 13, wherein the one or more predetermined factors comprises an identity of the merchant, a type of goods or services to be purchased, a geographical location of the consumer, and/or a time of the transaction.

15. The system of claim 10, wherein the merchant system comprises an online purchasing system or a point-of-sale system.

16. The method of claim 10, wherein the payment system indicates the required level of authentication to the merchant system.
